(19) United States
(12) Patent Application Publication
(10) Pub. No.: US 2006/0098090 A1
(43) Pub. Date: May 11, 2006

(54) Videoconference goniometer

(76) Inventors: Marie-Naoldeine Bernard, Ottawa Ontario (CA); Mathias Fruhwirth, Ottawa Ontario (CA)

Correspondence Address: Marie Nadeleine Bernard, 80 Harmer Avenue North, Ottawa, K1Y OT9, CA

(21) Appl. No.: 10/497,243

(22) PCT Filed: Dec. 2, 2002
(86) PCT No.: PCT/FR02/04121

§ 371 Date: Jun. 2, 2004

(30) Foreign Application Priority Data
Nov. 30, 2001 (FR) 01/15571

(51) Int. Cl. H04N 7/18

(52) U.S. Cl. 348/77

(57) ABSTRACT

The invention deals with the process and devices for the automated measure of the range of motion by means of a specialized videoconference systems connected to a network. The process consists of steps of: viewing in real-time on a display device an image of the parts of the body of a remotely located subject over a network with which the range of motion may be evaluated by the assignment, by an operator/evaluator of three points representing the anatomic landmarks making up the angle of a joint by means of a pointing device in the order distal anatomic landmark—joint—distal anatomic landmark, the automated subject image capture and calculation and display of the range of motion angle, the registration and recording to a database of the results of the evaluation. The invention is intended for the goniometric assessment of the range of motion in kinetics studies.

### 1. AREA OF CONCERN

The invention presented deals with the process and method for the automatic measurement of the range of motion, by the measure of the spatial position of a member or part of a member, of the subject, by means of an intermediary system specifically videoconference modified and designed to perform the goniometric functions employed in sports medicine, orthopaedic, kinesiotherapy, or ergonomics.

### 2. PRIOR ART

Traditionally the measurement of the range of motion was accomplished by the Universal Goniometer (UG). The UG included the following limitations.
Does not allow measurement at a distance, requiring the evaluator to be co-located with the subject.
Manual transcription of UG readings is a source of error. The fixed length of the UG arms (18 cm) requires an extrapolation which is prone to error.
Repeat measurements of past measurements are not possible nor the ability to measure same position from different remote locations by independent evaluators.

### 3. GENERAL SOLUTION

A procedure and mechanism, being the essence of the invention, permits the solution of the UC shortcomings

In the first place the procedure of the invention deals with the following:
a) Position of the camera with respect to the limb of the subject to be measured.
b) Visual observation by operator/evaluator of the subject by a locally positioned computing device with a presentation means, typically a screen, locally or remotely via network.
c) Recording the visible field, (captured image), be means of a mechanism triggered by pointing device operated by the evaluator (mouse) or the touch of the screen with the evaluators' finger. To Capture the image when the evaluator has determined that the position of the subject image is optimum
d) Identification by the operator/evaluator of 3 points corresponding to anatomical positions which form an angle the following order; distal—interligne artculaire—distal.
e) Transformation of the selected anatomical points (landmark) to an angle between linear segments and the calculation of the angle magnitude employing trigonometric principles.
f) Display of the calculated angle magnitude on the screen visible to the operator.
g) Modification if required of any single point representing the anatomic landmark to a new position, and automatically repeating procedures e) and f).
h) Repetition, if desired, of procedures d) through f), with automatic update of displayed angle magnitude, until the operator is satisfied with the calculated angle value.
i) Automatic storage in a database on a permanent recording medium, (magnetic or optical) of the captured image of the subject; the points representing the anatomic landmarks; the date and time and the unique identification of the subject.
j) The ability to transfer the database information to various media i.e. paper, magnetic disks, optical disk or non-volatile memory devices.

The proposed solution also permits the resolution of the following problems presented by the Universal Goniometer, GU:
a) The goniometric evaluation can be made at a distance with out the need for the subject to be at the location of the evaluator.
b) The identification of the points representing the anatomic landmarks can be made without the need for an extrapolation from the articulation points to the distal points, thereby improving the precision of the articulation angle measurement, particularly for inferior (lower body) members.
c) Automatic storage of resulting angle data for future analysis without the risk of error due to the manual transcription of data values and establishment of a record, both qualitative (subject visual image) and quantitative (previously identified points) allowing for the re-evaluation of measurements by the same or a different evaluator thereby achieving a less subjective (more objective) measurement.

According to a particular characteristic, remote display and remote point identification are also possible to have the simultaneous evaluations by two operators at separate locations over a network, thereby improving the evaluation, reliability and follow-up of the amplitude of the range of motion.

According to another characteristic, the range of motion may be assessed in the course of dynamic movements such as dance and ergonomy, by freezing selected postures.

The invention also involves a device to facilitate a procedure for the automated measurement of the range of motion by means of:
A camera to view the portion of the subject's body where an articulation is to be evaluated.
A personal computer, connected to the said camera, with a display device consisting of a computer monitor or commercial television and having the following minimum characteristics:
   a. 32 bit microprocessor operating at 200 MHz.
   b. 32 Mbytes volatile system memory
   c. 1.5 Gbytes non-volatile or hard disk memory,
allowing the operation of a customized videoconferencing application.
A telecommunications network with a communications bandwidth equal to or greater than 56 kilo bits per second, kbps for the transmission of captured images of the subject and equal to or 128 kbps for the observation of the range of motion before the capture of an image of the subject.
A means of recording a captured image for later evaluation of the magnitude of the angle of an articulated member.
A means of calculating, displaying, recording and printing the results of the procedure.

According to a particular characteristic, the telecommunications network may be using techniques employing Integrated Subscriber Digital Network, ISDN or Internet Protocol, IP, protocols on terrestrial or satellite communications links.

The invention also comprises a computer program for the execution of the steps of the procedure.

The two attached diagrams illustrate the invention:

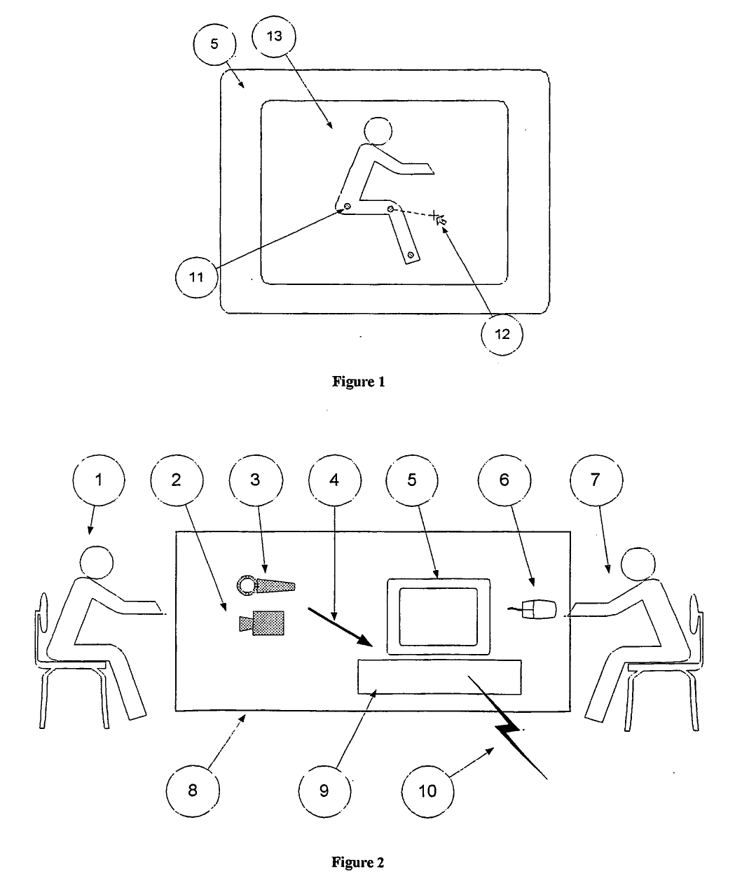

FIG. 1 illustrates a graphic visualization of the procedures on a display screen.

FIG. 2 illustrates the devices pertaining to the invention

For better understanding the invention is described with reference to the diagrams representing, but not limiting, an implementation of the procedures and devices.

As is evident, the devices illustrated in FIG. 2 allows the observer/operator (7) to visualize on the monitor screen (5) the movement of the articulating members of the subject (1), positioned before the camera (3) which can be oriented manually or by remote control. The camera (3) and microphone (2) are connected to a computer (4) or integrated with the computer. The operator employs a pointing device (mouse, 6) to capture an image of the part of the subject's body, where from the articulation angle measurement will be made. The computer and display screen (5) can be connected to a network (10) allowing the evaluator to observe, from a remote location, the subject's movements on his or her local display screen.

The image (13) on the display screen (5) is a representation of the subjects body form.

After capturing the image the operator/evaluator positions the pointing device cursor over each of the three points at the landmarks to be registered by the computer, by means of a confirmation action (manually activating a lever or “button” to trigger signal from the pointing device to the computer, commonly referred to as a “mouse click”) (11) and also with the aid of the apparatus the automated recording of the captured image and the acquired and calculated information.

1) A process for the automated measurement of the amplitude of the range of motion by the measurement of the spatial position of a body member or part of a member of an individual mediated by a system consisting of videoconference software application adapted to include goniometric measurements, including the following steps.
a) Localization by a camera of a part of the body where joint angle will be evaluated.
b) Real-time visualization by an operator by means of a display device over a network of an image of the remotely located subject.
c) Capture of an image initiated by means of a pointing device, such as a computer mouse or a touch screen to register the image deemed satisfactory by the operator/evaluator.
d) The identification by the operator of three points of the subject's anatomy (11) which form a joint angle and the registration by means of a pointing device in the order: anatomic distal landmark—anatomic joint landmark—anatomic distal landmark.
e) Transformation of the three anatomic landmarks to form an angle of the range of motion and the calculation of the angle magnitude employing trigonometric principles.
f) Display on the viewing device of the calculated range of motion angle magnitude.
g) If necessary, the modification of any of the anatomic landmark points by the pointing device and the automatic repetition of steps e and f
h) If necessary, a reiteration of the three steps (d, e, f) until the operator/evaluator is satisfied with the quality of the position of the points.
i) Registration and recording of the captured image, the anatomic landmark points, the calculated angle, the date of the evaluation, and the name of the operator/evaluator and subject.
j) Ability to print on paper and/or transcribe the captured images, points and angle data to recording media such as magnetic and optical disks.

2) The process for the automated and optimized measurement of the amplitude of the range of motion of any joint according to claim 1 with the following characteristics that:
The visualization and identification of the landmark points may be determined simultaneously by two operator/evaluators at separate locations or nodes of a common network.

3) The process for the automated and optimized measurement of the range of motion of any joint according to he claim 1) with the following characteristics that:
The angle calculation step may be made by a technique employing polar coordinates.

4) Devices for the implementation of the process for the automated and optimized measurement of the range of motion of any joint according to claims 1 to 3 with the following characteristics:
A camera to view the portion of the subject's body where an articulation is to be evaluated.
A personal computer, connected to the said camera, with a display device consisting of a computer monitor or commercial television and having the following minimum characteristics:
a. 32 bit microprocessor operating at 200 MHz.
b. 32 Mbytes volatile system memory
c. 1.5 Gbytes non-volatile or hard disk memory,
allowing the operation of a customized videoconferencing application.
A telecommunications network with a communications bandwidth equal to or greater than 56 kilo bits per second, kbps for the transmission of captured images of the subject and equal to or 128 kbps for the observation of movement before the capture of an image of the subject.
A means of recording a captured image for later evaluation of the magnitude of the angle of an articulated member.
A means of calculating, displaying, recording and printing the results of the procedure.

5) Devices according to claim 4) with the following characteristics that:
The computing devices are connected over a communications network with connections techniques employing Integrated Subscriber Digital Network, ISDN or Internet Protocol, IP, protocols on terrestrial or satellite communications links.

6) Software code which performs data registration and calculations and allows the steps of the process according to claims 1) to 3) when executed by an electronic computer.
